(19) United States
(12) Patent Application Publication
(10) Pub. No.: US 2011/0239495 A1
(43) Pub. Date: Oct. 6, 2011

(54) Curved Motorcycle License Plate Frame, Illuminated From Behind The Frame

(76) Inventor: Kenneth Puccio, Flagstaff, AZ (US)

(21) Appl. No.: 12/753,847

(22) Filed: Apr. 2, 2010

(51) Int. Cl. B60R 13/10

(52) U.S. Cl. 40/204

(57) ABSTRACT

This invention relates to motorcycles and more specifically custom motorcycles that have added a special rear fender that has a curved license plate recess that is built into it. This license plate frame is curved and fits into the recess of the custom fender that is located away from the tailight which traditionaly is the light source for the license plate. The license plate that it surrounds is illuminated independently by waterproof flexible strips of white light LED's that are attached with an automotive grade double sided tape to the inside edge of the frame and because they are flexible, take the curved shape of the frame. The LED's are spliced into the vehicle's tailight wiring system and are energized from the motorcycle battery when the tailight is on.

### REFERENCES CITED

U.S. Pat. No. 154,631 July 1925 Smith
U.S. Pat. No. 1,887,087 November 1932 Frazier
U.S. Pat. No. 2,526,460 October 1950 Crocella
U.S. Pat. No. 2,875,539 March 1959 Gladd
U.S. Pat. No. 4,857,890 August 1989 Solow
D327915 July 1992 Anderson et al

This invention relates to motorcycles and more specifically custom motorcycles that have added a special rear fender that has a curved license plate recess that is built into it. This license plate frame is curved and fits into the recess of the custom fender that is located away from the taillight which is the light source for the license plate. The license plate frame may me formed from plastic or any metal including zinc, aluminum and steel. The license plate that it surrounds is illuminated independently by waterproof flexible strips of white light LED's that are attached with an automotive grade double sided tape to the inside edge of the frame. The LED's are spliced into the vehicle's taillight wiring system and are energized from the motorcycle battery when the taillight is on.

### BACKGROUND OF THE INVENTION

Typically motorcycle license plate frames and the plate itself is flat and mounted on a bracket that is attached to the motorcycle and is illuminated through a clear portion of the taillight lens. Part of the problem with a curved license plate and frame is illuminating it bright enough at night. Special mounting hardware used in the four corners of the plate and frame with single LED's have been used but are sometimes not bright enough to satisfy state vehicle codes. Lighting on a traditional flat license plate are not as problematic, utilizing a rigid straight line light mounting system. This invention utilizes flexible strips of LED's that are easily adapted to the curvature of the license plate frame and emit plenty of light to satisfy legal requirements.

### SUMMARY OF THE INVENTION

This invention is intended to satisfy legal requirements of the States they are used in by emitting a bright light. It is also intended to light the license plate from the inside edge of the license plate frame independently of the motorcycle taillight and give the motorcycle a custom look when using an after market wide fender that has a built in curved license plate and frame recess. Insufficient night time lighting is solved using flexible LED mounting strips that contain more lights than the traditional single lights used in the four mounting corners.

Custom wide fenders have become increasingly popular among the heavy cruiser style motorcycle enthusiast and are being manufactured by several companies. This invention is a perfect compliment to these custom fenders.

### BRIEF DESCRIPTION OF THE DRAWINGS

FIG. 1. is a front perspective view showing the curvature of the motorcycle license plate frame.

FIG. 2. is a rear view, but for illustration purposes it is depicted as FLAT without any curve.

### DETAILED DESCRIPTION OF THE DRAWINGS

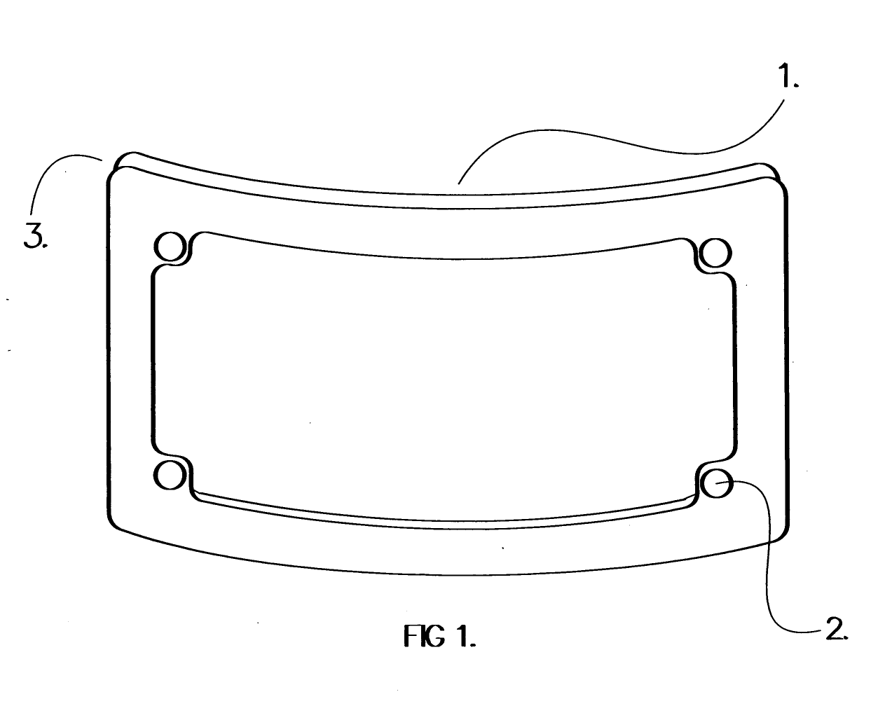

FIG. 1. #1 shows the curvature of the license plate frame that will match the curve of a wide custom motorcycle fender. The curvature is equal on both top and bottom.

FIG. 1. #2 shows the four mounting holes that the frame is mounted to the license plate and fender.

FIG. 1. #3 shows the width of the frame, approximately 1 inch on top and ¾ inch on the bottom. This conceals the LED lights that are mounted behind. The sides are about ½ inch wide to conceal the electrical wires to the LED's.

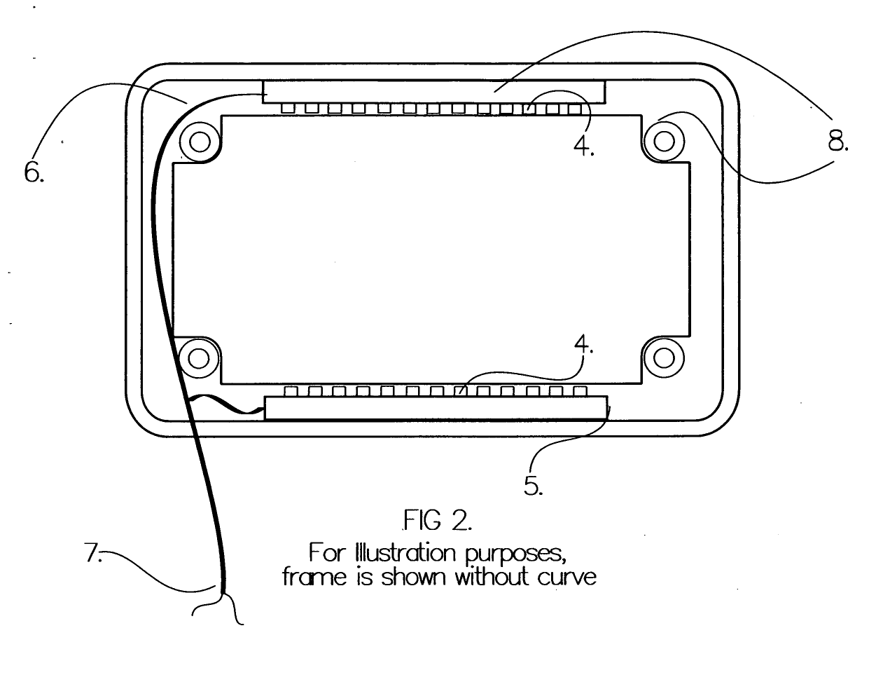

FIG. 2. #4 shows two rows of LED's, one each top and bottom. These strips are the heart of the invention because they are flexible and are partly embedded in silicone to make them waterproof.

FIG. 2. #5 shows the silicone type material the lights are embedded in. This also shows the automotive grade double sided tape the is used to attach the LED's to the license plate frame. This tape is the same type that attach chrome and trim to the outside of car panels. Very strong.

FIG. 2. #6 are the double insulated electrical supply wires.

FIG. 2. #7 are the 12 volt electrical leads that are spliced into the motorcycles taillight for power.

FIG. 2. #8 is a dotted rectangular line that depicts the installed license plate in back of the upper and lower row of LED's approximately ¼ inch behind the frame. Nylon spacers around the mounting screws an be used to fill this gap.

In use, the license plate frame provides both illumination for the license plate and enhanced aesthetic appeal. Additionally, the use of many LED's provides extra visibility to other motorists after dark. While the invention has been illustrated and described in detail in the drawings and foregoing description, the same is to be considered as illustrative and not restrictive in character, it being understood that only the preferred embodiment has been shown and described in detail and that all changes and modifications that come within the spirit of the invention are desired to be protected.

I claim:

1. A curved motorcycle license plate frame made from a structural material; the license plate that it is attached to is illuminated at night independently by multiple LED's that are partially embedded into a flexible waterproof strip that will take on the curved form of the license plate frame and are attached to the inside edges of the license plate frame; The LED's are bright enough to more than satisfy the legal requirements of the states motor vehicle codes.

2. Illumination for a License Plate originates from behind a License Plate Frames edges and is attached to said edges
